(19) United States
(12) Patent Application Publication
(10) Pub. No.: US 2013/0159142 A1
(43) Pub. Date: Jun. 20, 2013

(54) SYSTEM AND METHOD FOR AUTOMATING REAL ESTATE MATCHING

(71) Applicants: Eli Moreno, Tacoma, WA (US); Amber Lynn Moreno, Tacoma, WA (US)

(72) Inventors: Eli Moreno, Tacoma, WA (US); Amber Lynn Moreno, Tacoma, WA (US)

(21) Appl. No.: 13/562,376

(22) Filed: Jul. 31, 2012

Related U.S. Application Data
(60) Provisional application No. 61/570,998, filed on Dec. 15, 2011.

(51) Int. Cl. G06Q 30/00

(52) U.S. Cl. 705/26.63

(57) ABSTRACT

The present invention generally relates to computer implemented real estate services. Specifically, this invention relates to a computer implemented system and method for automatically matching users with real estate (e.g., apartments, rental units, condos, houses) that both fit a user's criteria, but also for which the system has received pre-approval for based on one or more criteria associated with the user (e.g., credit scores).

### CROSS REFERENCE TO RELATED APPLICATIONS

This application claims the benefit of U.S. Provisional Patent Application No. 61/570,998 filed Dec. 15, 2011, the entire disclosure of which is incorporated herein by reference.

### FIELD OF THE INVENTION

The present invention generally relates to computer implemented real estate services. Specifically, this invention relates to a computer implemented system and method for automatically matching users with real estate (e.g., apartments, rental units, condos, houses) that both fit a user's criteria, but also for which the system has received pre-approval for based on one or more criteria associated with the user (e.g., credit scores).

### BACKGROUND

The process for finding, applying for and renting an apartment or other real estate is one that has remained largely unchanged in the past several decades. Renters search for and find apartments that interest them through one or more sources, such as online or print advertisements, through web searches or through word of mouth. The renter then applies for approval with a rental agency or owner of the apartment to confirm their ability to pay for and not otherwise damage or cause harm to the apartment of other individuals residing in the complex or area. Approval usually consists of a check of the renter's credit rating, background, payment history or any combination thereof. The renter must individually apply for each apartment they are interested in with no prior awareness as to whether they will qualify for the unit or not.

While there are systems that provide a user (e.g., renter) the ability to find available real estate listings based on identified search criteria, these systems still require the user to go through the approval process for each real estate listing they are interested in as each listing person or entity may have differing approval requirements, even where the real estate listings are identical or virtually identical.

Currently, there are no systems that allow for a user interested in real estate to find real estate that fits the user's desired criteria while also allowing for the user to be pre-approved for each real estate listing prior to displaying the real estate listing to the user. This works both to allow the user the ability to be approved for multiple real estate listings (e.g., apartments) at once, but also works to eliminate wasted time applying for each real estate listing individually and being rejected for certain real estate listings that the user does not qualify for.

Therefore, there is need in the art for a system and method for providing automated real estate matching based at least in part on user criteria and criteria associated with the user. These and other features and advantages of the present invention will be explained and will become obvious to one skilled in the art through the summary of the invention that follows.

### SUMMARY OF THE INVENTION

Accordingly, it is an aspect of the present invention to provide a system and method for automated real estate matching based at least in part on user criteria and criteria associated with the user.

According to an embodiment of the present invention, a system for automating real estate matching includes: a computing device, the computing device comprising physical memory storing instructions that cause the computing device to: receive an inquiry from a user, wherein said inquiry comprises information regarding real estate characteristics the user is interested in; check the background characteristics of the user; retrieve one or more real estate listings matching both the inquiry and the background characteristics of the user; and provide one or more real estate listings to said user.

According to an embodiment of the present invention the physical memory further comprises instructions that cause the computing device to receive a selection of one or more of said one or more real estate listings from said user.

According to an embodiment of the present invention, the physical memory further comprises instructions that cause the computing device schedule a tour of at least one of said one or more real estate listings selected by said user.

According to an embodiment of the present invention, the computing device pre-approves the user for said one or more real estate listings.

According to an embodiment of the present invention, the pre-approval includes verifying the user can afford said one or more real estate listings based at least in part on the background characteristics of the user.

According to an embodiment of the present invention, the background characteristics include one or more of a credit score, a criminal background check, an employment check and an income verification.

According to an embodiment of the present invention, the physical memory further comprises instructions that cause the computing device to generate an application for a transaction related to at least one of said one or more real estate listings selected by said user.

According to an embodiment of the present invention, transactions are one or more of a rental transaction, a purchase transaction, a lease transaction, a mortgage transaction and a financed transaction.

According to an embodiment of the present invention, applications may include one or more of a purchase application, a rental application, a lease application, a mortgage application, a purchase offer and a short-sale offer.

According to an embodiment of the present invention, the physical memory further include instructions that cause the computing device to generate neighborhood information related to said one or more real estate listings selected by said user, wherein said neighborhood information comprises one or more of school information, crime information, geographic location information and points of interest information; and provide said neighborhood information to said user.

According to an embodiment of the present invention, a method for automating real estate matching includes the steps of: receiving an inquiry from a user, at a computing device, wherein said inquiry comprises information regarding real estate characteristics the user is interested in; checking the background characteristics of the user; retrieving one or more real estate listings matching both the inquiry and the background characteristics of the user; and providing one or more real estate listings to said user.

According to an embodiment of the present invention, the method for automating real estate matching may further include the step of receiving a selection of one or more of said one or more real estate listings from said user.

According to an embodiment of the present invention, the method for automating real estate matching may further include the step of scheduling a tour of at least one of said one or more real estate listings selected by said user.

According to an embodiment of the present invention, the method for automating real estate matching may further include the step of generating an application for a transaction related to at least one of said one or more real estate listings selected by said user.

According to an embodiment of the present invention, the method for automating real estate matching may further include the step of generating neighborhood information related to said one or more real estate listings selected by said user, wherein said neighborhood information comprises one or more of school information, crime information, geographic location information and points of interest information; and providing said neighborhood information to said user.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a network schematic of a system, in accordance with an embodiment of the present invention;

FIG. 2 illustrates a schematic overview of a computing device, in accordance with an embodiment of the present invention;

FIG. 3 is a process flow of an exemplary embodiment of a method in accordance with the present invention; and

FIG. 4 is a detailed process flow of an exemplary embodiment of a method in accordance with the present invention.

### DETAILED SPECIFICATION

The present invention generally relates to computer implemented real estate services. Specifically, this invention relates to a computer implemented system and method for automatically matching users with real estate (e.g., apartments, rental units, condos, houses) that both fit a user's criteria, but also for which the system has received pre-approval for based on one or more criteria associated with the user (e.g., credit scores).

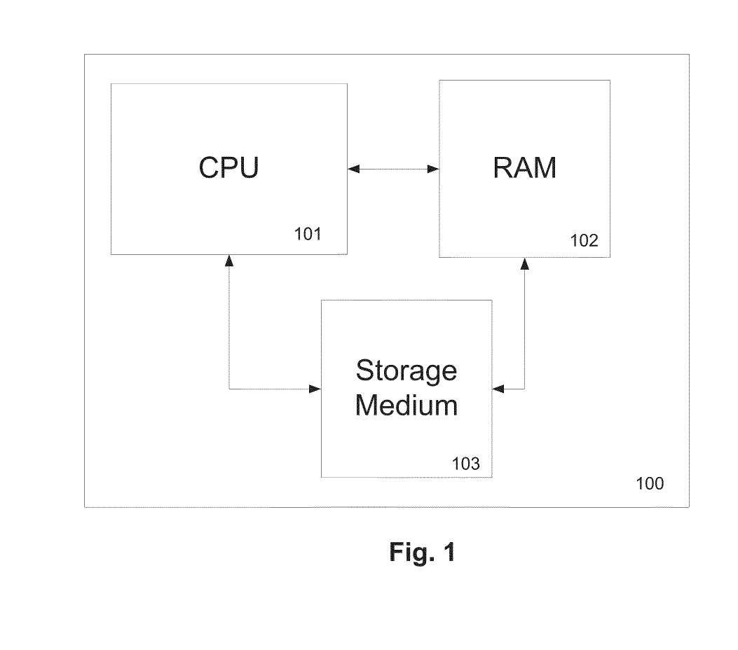

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

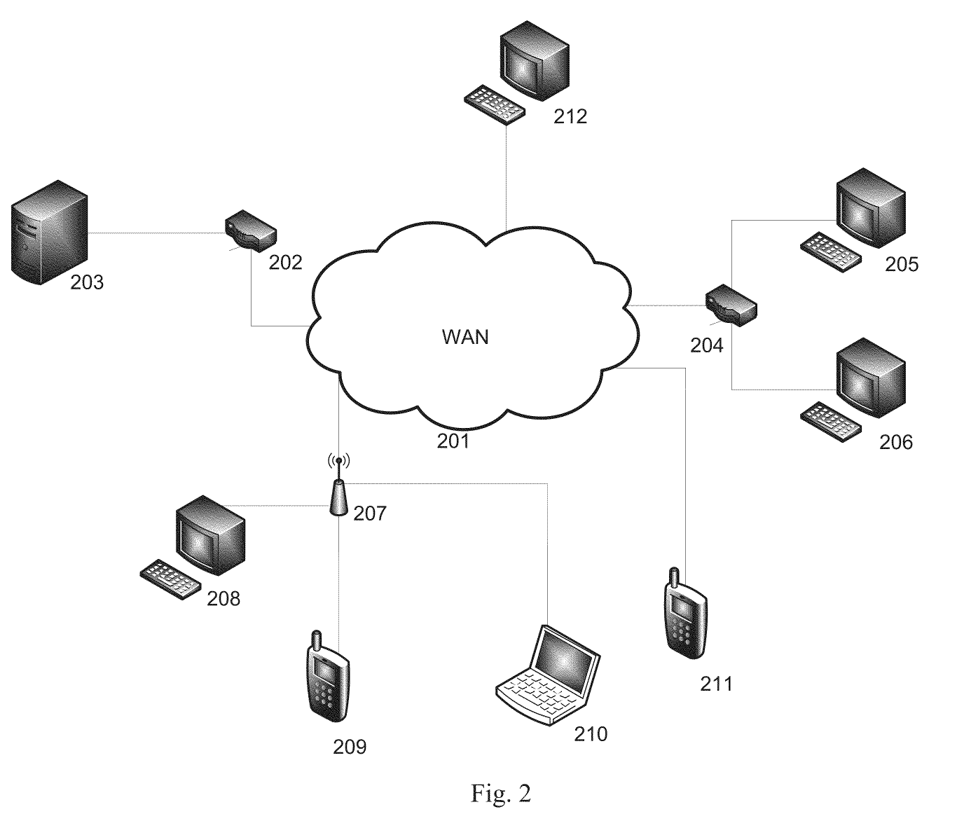

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an embodiment of the present invention, the system is configured to provide users the ability be automatically matched with one or more real estate listings based on criteria a user provides to the system. Criteria includes, but is not limited to, square footage, number of bedrooms, number of bathrooms, type of real estate property (e.g., residential, commercial, condo, townhouse, single family home, undeveloped, rental unit), location, geographic properties (e.g., close to public transportation, lake front, school district) or any combination thereof. One of ordinary skill in the art would appreciate that there are numerous types of criteria that may be utilized in embodiments of the present invention, and embodiments of the present invention are contemplated for use with any type of criteria.

According to an embodiment of the present invention, the system may require the user to provide certain required criteria in order to process a request. For instance, the system may require the user provide their social security number, birth date, full name, current address or other information necessary to prove the identity and other important characteristics of the user (e.g., credit score, criminal history). One of ordinary skill in the art would appreciate that there are numerous types of required criteria that may be utilized in embodiments of the present invention, and embodiments of the present invention are contemplated for use with any type of required criteria. Further, the type of required criteria may vary depending on the desired type of property listing the user is looking for (e.g., rental v. purchase listings).

According to an embodiment of the present invention, once the system has received the pertinent criteria, including the required criteria, from the user, the system is configured to dynamically generate a set of real estate listings for which the user has prequalified for. For instance, a user may provide the system with a set of required criteria and criteria identifying the desire to find a one bedroom apartment for rent in a specific neighborhood. The system will then utilize this information to obtain preapprovals for the user on one or more apartments matching both the user's criteria and specifics associated with the listed properties.

According to an embodiment of the present invention, the system is configured to store or otherwise have access to information related to available properties (i.e., listed properties). Information related to available properties may be provided on a real time, near real time or static basis. Information related to available properties may be, for instance, stored locally by the system, stored remotely by the system, accessible by the system via one or more application programming interfaces (APIs), including APIs provided by third party providers. In an exemplary embodiment, the system may be configured to receive information related to available properties from third party systems, such as those provided by multiple listing service providers. One of ordinary skill in the art would appreciate that there are numerous ways to store, retrieve or otherwise receive information related to available properties, and embodiments of the present invention are contemplated for use with any method for storing, retrieving or otherwise receiving information related to available properties.

According to an embodiment of the present invention, the system may be configured to allow landlords, property owners or other individuals or companies associated with one or more real estate listings, the ability to insert one or more real estate listings into to the system (“Inserting Users”). By inserting real estate listings directly into the system, the system can verify the accuracy of the real estate listing and confirm specific requirements associated with the one or more real estate listings (e.g., minimum credit scores). The system may also provide inserting users the ability to feature or otherwise promote their real estate listings (e.g., by paying a fee for special placement in user results).

According to an embodiment of the present invention, the system is configured to automatically match and preapprove users with one or more real estate listings based on the information provided by the user and the information related to available properties. Once matched, the system is further configured to provide relevant matches to the user, including providing searching and sorting features to allow the user to easily view and consume the data provided.

According to an embodiment of the present invention, the system may be further configured to allow the user to select one or more matched properties and schedule visits or other next-step arrangements for the user (e.g., mortgage application transmission, rental application transmission, submission of down payment(s)). In this manner, the system provides the user the ability to not only quickly review matched properties, but to also act quickly on properties the user is interested in. This can be particularly useful in locations where listings come and go quickly (e.g., New York City apartments).

According to an embodiment of the present invention, the system may be configured to provide the user with additional information related to the real estate property listings based on one or more data points associated with the real estate property listing. For instance, the system may be configured to pull news reports, school information, crime reports or statistics for the area or other relevant information associated with the real estate property, its geographic location or other data point. In this manner, the user may be given a better understanding of the area or other specifics associated with a real estate listing. One of ordinary skill in the art would appreciate that there are numerous data points and pieces of relevant information that may be utilized by embodiments of the present invention, and embodiments of the present invention are contemplated for use with any data point or piece of relevant information.

### Exemplary Embodiment

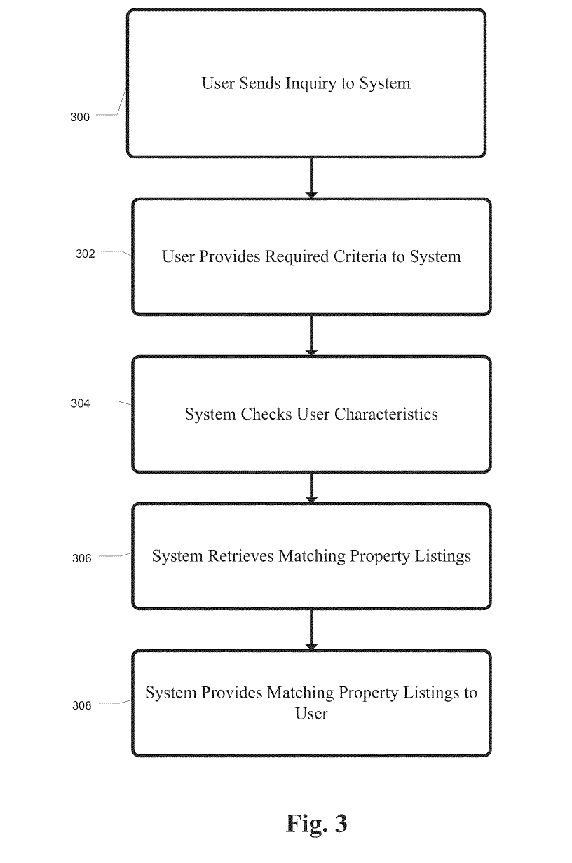

The following is an exemplary embodiment of a method for automating real estate matching to one or more users, as shown in FIG. 3. At step 300, the user sends an inquiry to the system related to finding a real estate listing that matches the user's needs/desires. In a preferred embodiment, in order to facilitate this step, the system will provide a graphical user interface with regions provided to allow the user to enter information related to one or more criteria associated with real estate listings.

At step 302, the system will request and the user will provide required criteria, as previously described herein. In a preferred embodiment, the system will request required criteria that will enable and allow it to run a credit report on the user. Optionally, the system may be further configured to run criminal background checks and other financial reports related to the user.

At step 304, the system utilizes the information provided by the user to check the characteristics of the user. In a preferred embodiment of the present invention, the system is configured to run a credit report based on the user's required criteria and other information. Optionally, the system may be further configured to run other background checks on the user.

At step 306, the system utilizes the characteristics of the user determined in step 304 to identify one or more properties listings that match both the characteristics of the user and the criteria provided by the user. The system may also organize the results by one or more characteristics (e.g., how close of a match the property listing is to the user's criteria).

At step 308, the system provides the one or more property listings to the user. This may be done with the assistance of a graphical user interface configured to display the listings in an optimal manner or in a manner so defined by the user (e.g., grid, vertical list, detailed view).

Optionally, and not shown in the method of FIG. 3, the system may further allow the user to identify one or more property listings he/she is interested in and proceed to take further actions on those property listings, either through the system, as described above, or through other manual means.

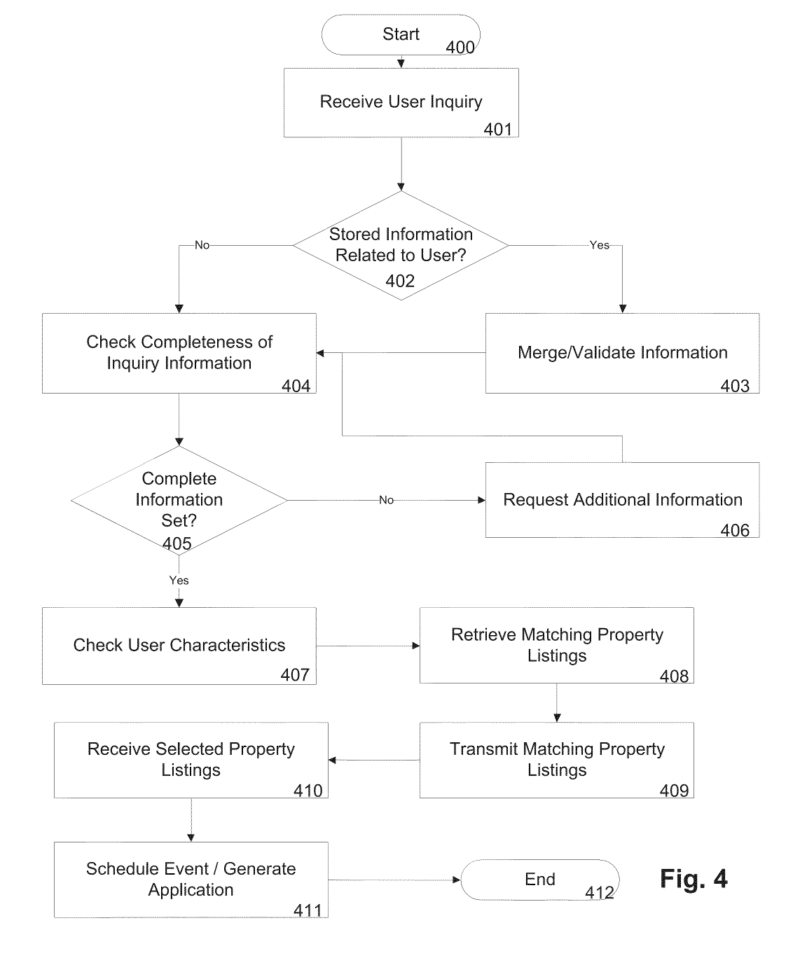

Turning now to FIG. 4, a detailed embodiment of a method for automating real estate matching to one or more users, is shown. At step 400, the user sends an inquiry to the system similar to that as shown in FIG. 3 and the description above.

At step 401, the system receives an inquiry from a user, as previously described herein. An inquiry may be comprised of a set amount of previously requested material of a set of materials chosen or identified by a user. In this manner, a user can disclose only the amount of information they feel comfortable with, even if the system may later require additional information to proceed with a specific inquiry. This may be advantageous in that each inquiry type (e.g., purchase, lease, rental) may require different levels of information and not all inquiries may require the same amount of information as other inquires.

At step 402, the system confirms whether or not this is the user's first use of the system. If this is not the first use of the system by the user, the system may have stored information related to the user, such as their social security number, previously viewed property preferences and other information related to the user, their desires, their previous interactions with the system and the various completed or pending events and transactions.

If the system has stored information on the user, the system proceeds to step 403, where the system may be configured to insert new information provided by the user in the inquiry as well as validate previously provided information allowing the user to either supply replacement information for previously provided information, provide new information, supplement existing information or any combination thereof.

At step 404, the system checks the completeness of the inquiry information for a transaction type identified by the user in the inquiry. For instance, if the user is attempting to view rental properties in a specific area, the system may confirm that the user has provided enough information for the system to both provide relevant listings and verify the user's ability to be qualified to rent listed properties.

At step 405, the system determines whether the information set is complete as required in step 404. If no, the system proceeds to step 406, whereby the system requests additional information or updated information from the user. This loop may continue until the system has the necessary amount of information required to complete the inquiry.

At step 407, the system checks the user's information and characteristics and generates a user profile from this information. For instance, the system may take the user's social security number and other information to check the user's credit score, criminal history, employment information, income information or any combination thereof. Once the system has confirmed the user's characteristics and formed the user profile, the system may proceed. In certain embodiments, user's characteristics and a user profile may be temporarily utilized by the system (e.g., 30 days), allowing the user to utilize a current validated profile, but expiring this profile after the elapse of some time period or event in order to ensure accurate characteristics and profiles.

At step 408, the system retrieves property listings that match the inquiry submitted. Matched properties are matched in relation to the user's desires and the user's characteristics as confirmed by the system, as detailed above. At step 409, the system transmits these matched property listings to the user.

At step 410, the system receives one or more selected property listings from the user as well as a request to perform some action or event on the selected properties. Events include, scheduling a time to visit a property associated with the selected listing and actions include requesting the preparation of a rental application, a purchase application, a mortgage application, an offer or other transaction request.

At step 411, the system is configured to schedule events and/or generate the appropriate applications as requested by the user. For instance, the system may be configured to take the information provided by the user in the inquiry, as well as any stored information, and generate a completed rental application on the user's behalf. The user may sign and submit the application or the system may allow the user to electronically sign the application and submit the application electronically to the appropriate parties.

At step 412, the process terminates.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for automating real estate matching, said system comprising:
a computing device, the computing device comprising physical memory storing instructions that cause the computing device to:
receive an inquiry from a user, wherein said inquiry comprises information regarding real estate characteristics the user is interested in;
collect user background characteristics from the user, wherein said background characteristics comprise information to preapprove the user for one or more real estate transactions from the group comprising rental transactions, a purchase transactions, a lease transactions, a mortgage transactions, and a financed transactions;
retrieve one or more real estate listings that matches the inquiry of the user;
analyze said user background characteristics, wherein the computing device preapproves the user for one or more of said real estate transactions associated with said one or more real estate listings; and
provide the user with a suggested real estate list, wherein said suggested real estate list comprises one or more of said one or more real estate listings for which the user is preapproved for one or more real estate transactions.

2. The system of claim 1, wherein said physical memory further comprises instructions that cause the computing device to receive a selection of one or more of said one or more real estate listings from said user.

3. The system of claim 2, wherein said physical memory further comprises instructions that cause the computing device schedule a tour of at least one of said one or more real estate listings selected by said user.

4. (canceled)

5. The system of claim 4, wherein said pre-approval includes verifying said user can afford said one or more real estate listings based at least in part on the background characteristics of the user.

6. The system of claim 1, wherein said background characteristics include one or more of a credit score, a criminal background check, an employment check and an income verification.

7. The system of claim 2, wherein said physical memory further comprises instructions that cause the computing device to generate an application for a transaction related to at least one of said one or more real estate listings selected by said user.

8. The system of claim 7, wherein said transaction is one or more of a rental transaction, a purchase transaction, a lease transaction, a mortgage transaction and a financed transaction.

9. The system of claim 7, wherein said application is one or more of a purchase application, a rental application, a lease application, a mortgage application, a purchase offer and a short-sale offer.

10. The system of claim 2, wherein said physical memory further comprises instructions that cause the computing device to generate neighborhood information related to said one or more real estate listings selected by said user, wherein said neighborhood information comprises one or more of school information, crime information, geographic location information and points of interest information; and provide said neighborhood information to said user.

11. A method for automating real estate matching, the method comprising the steps of:
receiving an inquiry from a user, at a computing device, wherein said inquiry comprises information regarding real estate characteristics the user is interested in;
collecting user background characteristics from the user, wherein said background characteristics comprise information to preapprove the user for one or more real estate transactions from the group comprising rental transactions, a purchase transactions, a lease transactions, a mortgage transactions, and a financed transactions;
retrieving one or more real estate listings that matches the inquiry of the user;
analyzing said user background characteristics, wherein the computing device preapproves the user for one or more of said real estate transactions associated with said one or more real estate listings; and
providing the suer with a suggested real estate list, wherein said suggested real estate list comprises one or more of said one or more real estate listings for which the user is preapproved for one or more real estate transactions.

12. The method of claim 11, further comprising the step of receiving a selection of one or more of said one or more real estate listings from said user.

13. The method of claim 12, further comprising the step of scheduling a tour of at least one of said one or more real estate listings selected by said user.

14. (canceled)

15. The method of claim 14, wherein said pre-approval includes verifying said user can afford said one or more real estate listings based at least in part on the background characteristics of the user.

16. The method of claim 11, wherein said background characteristics include one or more of a credit score, a criminal background check, an employment check and an income verification.

17. The method of claim 12, further comprising the step of generating an application for a transaction related to at least one of said one or more real estate listings selected by said user.

18. The method of claim 17, wherein said transaction is one or more of a rental transaction, a purchase transaction, a lease transaction, a mortgage transaction and a financed transaction.

19. The method of claim 17, wherein said application is one or more of a purchase application, a rental application, a lease application, a mortgage application, a purchase offer and a short-sale offer.

20. The method of claim 12, further comprising the step of generating neighborhood information related to said one or more real estate listings selected by said user, wherein said neighborhood information comprises one or more of school information, crime information, geographic location information and points of interest information; and providing said neighborhood information to said user.
